(19) United States
(12) Patent Application Publication
(10) Pub. No.: US 2008/0203341 A1
(43) Pub. Date: Aug. 28, 2008

(54) Electrically Controlled Valve

(75) Inventors: Hans-Jorg Feigel, Rosbach (DE); Jan Hoffman, Rosbach (DE)

Correspondence Address: RATNERPRESTIA, P O BOX 980, VALLEY FORGE, PA, 19482-0980, US

(73) Assignee: CONTINENTAL TEVES AG & CO. OHG, Frankfurt (DE)

(21) Appl. No.: 11/995,151

(22) PCT Filed: Jul. 11, 2006
(86) PCT No.: PCT/EP06/64072

§ 371 Date: Jan. 9, 2008

(30) Foreign Application Priority Data
Jul. 20, 2005 (DE) 10 2005 033 877.1
Feb. 16, 2006 (DE) 10 2006 007 157.3

(51) Int. Cl. F16K 31/06; F16F 9/00; F16F 7/00

(52) U.S. Cl. 251/129.1; 251/129.01

(57) ABSTRACT

An electrically controlled valve, in particular for the variable adjustment of the damper characteristic curve of a vibration damper, comprising a magnetic drive for actuating a valve slide that is guided in a housing in one moving direction, as well as a passage arranged in the housing between a valve inlet and a valve outlet for the variable volume flow control, the passage cooperating with a control edge of the valve slide. The moving direction of the valve slide is electrically reversible, thereby resulting in a comparatively simple mechanical layout for the valve for variably controlling the characteristic curve of the valve.

This application is the U.S. national phase application of PCT International Application No. PCT/EP2006/064072, filed Jul. 11, 2006, which claims priority to German Patent Application No. DE102005033877.1, filed Jul. 20, 2005 and German Patent Application No. DE102006007157.3, filed Feb. 16, 2006, the contents of such applications being incorporated by reference herein.

### BACKGROUND OF THE INVENTION

1. Field of the Invention

The present invention relates to an electrically controlled valve, in particular for use in a shock absorber.

2. Description of the Related Art

EP 0 627 052 B1 discloses a valve of the generic type, the valve slide of which carries a moving coil whose current supply is executed by way of a bending spring defining the basic positioning of the valve slide in the housing. The housing carries a permanent magnet cooperating with the moving coil so that comparatively great effort and structure is needed in total for the electromechanical actuation of the valve slide in one single direction of actuation.

The position of the valve slide is determined by means of a separate measuring device, which is composed of a sensor element on the housing and a permanent magnet connected to the valve slide. This arrangement equally increases the cost and complexity of construction and, in connection with the moving coil at the valve slide, increases the mass as well as consequently the system's inertia.

### SUMMARY OF THE INVENTION

An object of the invention involves designing a valve of the indicated type with minimum possible effort in such a fashion that the valve slide provides a permanently high control dynamics irrespective of its moving direction, while using simple, functionally reliable means and while avoiding the above-mentioned drawbacks.

According to the invention, this object is achieved for a valve of the type referred to hereinabove by means of a valve wherein the moving direction of the valve slide is electrically reversible.

Further features, advantages, and possible applications of the invention can be seen in the following description of an embodiment.

### BRIEF DESCRIPTION OF THE DRAWINGS

FIG. 1 is a schematic longitudinal view of a slide valve, which is electrically directly controlled in two diametrical moving directions and is preferably used for variably adjusting the damping characteristic curve of a vibration damper.

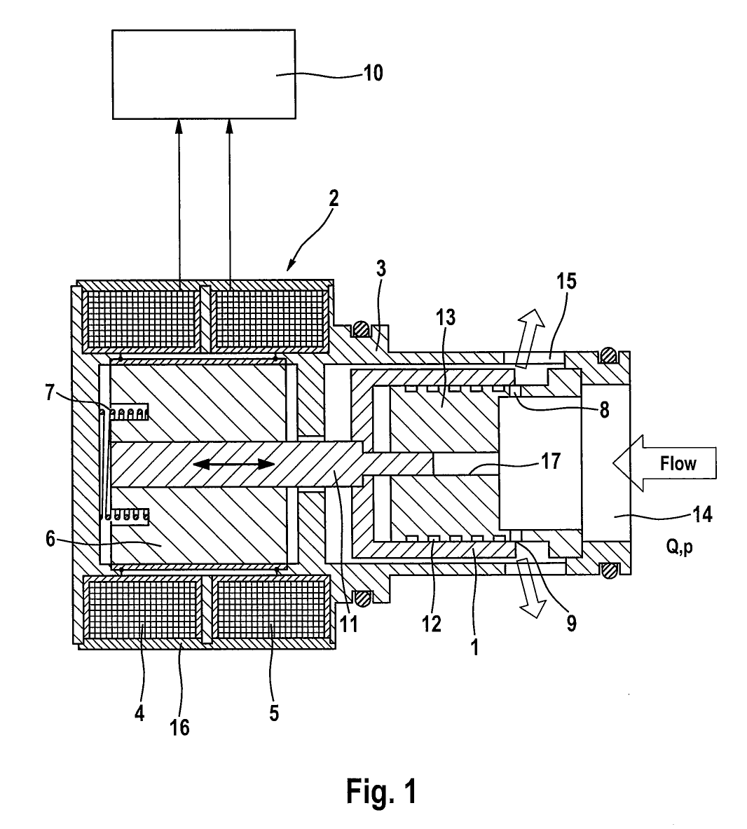

### DETAILED DESCRIPTION

For actuation of a valve slide 1 that is guided in a housing 3, the valve includes a magnetic drive 2, which actuates the valve slide 1 in the housing 3 for the variable volume flow control between a valve inlet 14 and a valve outlet 15 in such a manner that a passage 8 arranged in the housing 3 is invariably opened or closed by a control edge 9 of the valve slide 1.

Therefore, the invention arranges that the moving direction of the valve slide 1 can be reversed depending on the electric energization of the magnetic drive 2, to what end the valve slide 1 can be driven by a magnetic drive 2 provided as a reversible lifting magnet.

For this purpose, the magnetic drive 2 includes a first and a second magnet coil 4, 5 being fixed at the housing 3, the said coils being electrically actuatable into the one or the other direction jointly or irrespective of one another for the optional actuation of the armature 6 that is connected to the valve slide 1. The two magnet coils 4, 5 are serially arranged, coaxially aligned along the tubular housing 3, and are encompassed by a sleeve-shaped yoke sheet 16, which establishes the magnetic circuit via the housing 3 to the armature 6.

Depending on the electric energization of the two magnet coils 4, 5, a current-proportional longitudinal movement of the armature 6 and the valve slide 1 that is rigidly coupled to the armature 6 out of the illustrated mid-position (basic position) to the left or to the right is thus brought about in order to influence the throttling effect in passage 8.

The armature 6 arranged within the magnet coils 4, 5 in housing 3 is acted upon by a spring 7 causing the valve slide 1 to adopt the illustrated basic position in the electrically non-energized condition of the two magnet coils 4, 5, in which basic position the control edge 9 opens the passage 8 at least in part. It is thus ensured that a sufficient quantity of volume flow can pass through the passage 8 at any time if the electric energy supply fails. Spring 7 preferably has the design of a compression spring. Of course, it may also be configured as a tension spring, if so desired or required.

In its capacity as a cylindrical compression spring, spring 7 is compressed directly between the left end face of the armature 6, which is remote from the valve slide 1 and is furnished with an indentation, and the end wall of the housing 3, whereby a compact spring assembly is achieved.

By way of a tappet 11 that can be acted upon hydraulically by the inlet pressure, the armature 6 is rigidly connected to the valve slide 1 designed as a hollow slide, with the result that the positioning of the valve slide 1 in its mid-position is supported due to the hydraulic pressure reaction to the tappet 11. Valve slide 1 is guided in a movable and leakage-free manner by means of an inside centering on an internal cylinder 13 equipped with several circumferential grooves 12.

In the illustrated embodiment, the internal cylinder 13 as a separate component is fitted concentrically into the tubular housing 3 having the valve inlet 14 at its frontal end.

Upstream of the circumferential grooves 12, the internal cylinder 13 includes the passage 8. Passage 8, which cooperates with the control edge 9 of the valve slide 1, is configured as a transverse bore extending through the wall of the internal cylinder 13. Preferably, the internal cylinder 13 is manufactured as a turned part in conformity with the demands of automatic machines, and the end of the tappet 11 that projects within the valve slide 1 is immersed and guided in the central bore 17 of the turned part. The valve outlet 15 disposed downstream of the passage 8 extends through the wall of the housing 3.

The valve slide 1 can be designed especially simply as a bowl-shaped hollow slide, the bowl bottom of which connects to the piston-shaped armature 6 by way of the tappet 11. The bowl rim remote from the bowl bottom favorably assumes the function of the control edge 9. The valve slide 1 lends itself to especially efficient manufacture as a deepdrawn part corresponding to the geometry explained hereinabove. The inside periphery of the valve slide 1 disposed between the bowl bottom and the bowl rim is guided in a low-friction manner by way of a metallic sealing along the outside periphery of the internal cylinder, which includes the initially mentioned circumferential grooves 12, whereby undesirable leakage flows are avoided in the way of a labyrinth packing.

The position of the valve slide 1 can be detected using a suitable measuring device for the purpose of precise volume flow control. Due to the magnetic drive 2 as employed, the measuring device in a particularly favorable way has the design of an induction measuring device, which measures the current in at least one of the two magnet coils 4, 5 that is induced by the movement of the armature 6. Thus, the magnet coils 4, 5 must be considered as a component of the measuring device, which is combined with a symbolically sketched evaluating circuit 10. Hence, the evaluating circuit 10 helps precisely detect the stroke position of the valve slide 1 depending on the position of the armature 6.

In at least one aspect, the valve of the present invention provides an especially simple mechanical layout that lends itself to low-cost manufacture. Due to the low masses to be moved in the housing 3 with low resistance, a highly dynamic slide control with a comparatively low current consumption is realized in both directions of actuation of the valve slide 1, taking into consideration the magnetic drive 2 chosen, and it is possible, if desired or required, to depict a variable valve characteristic curve with clearly defined pressure/volume characteristics by way of the selected magnetic drive 2.

1-10. (canceled)

11. Electrically controlled valve comprising:
a housing having a passage arranged therein between a valve inlet and a valve outlet for variable volume flow control; and
a magnetic drive for actuating a valve slide that is guided in the housing in one moving direction and has a control edge which cooperates with the passage, wherein the moving direction of the valve slide is electrically reversible.

12. Valve as claimed in claim 11, wherein the moving direction of the valve slide is reversible depending on an electric energization of the magnetic drive.

13. Valve as claimed in claim 11, wherein the magnetic drive includes a first and a second magnet coil fixed at the housing, the coils being electrically excitable into the one direction or the other direction jointly or irrespective of one another for the actuation of an armature that is connected to the valve slide.

14. Valve as claimed in claim 13, wherein the armature is acted upon by a spring causing the valve slide to adopt a basic position in the electrically non-energized condition of the two magnet coils, in which basic position the control edge of the valve slide opens the passage at least in part.

15. Valve as claimed in claim 11, wherein the position of the valve slide can be determined using a suitable measuring device.

16. Valve as claimed in claim 13, wherein the position of the valve slide can be determined using a suitable measuring device including an induction measuring device which detects the current induced in at least one of the two magnet coils by movement of the armature.

17. Valve as claimed in claim 16, wherein the measuring device is combined with an evaluating circuit, which allows determining the position of the valve slide depending on the position of the armature.

18. Valve as claimed in claim 13, wherein the valve slide is a hollow slide and the armature is connected to the valve slide by way of a tappet that can be acted upon hydraulically by an inlet pressure

19. Valve as claimed in claim 18, wherein the valve slide is slidingly guided by means of an inside centering on an internal cylinder which is a component part of the housing and includes a plurality of circumferential grooves.

20. Valve as claimed in claim 18, wherein the valve slide is configured as a bowl-shaped hollow slide, the bowl bottom of which is connected to the tappet, with the bowl rim remote from the bowl bottom including the control edge.

21. Valve as claimed in claim 19, wherein the passage is configured as a transverse bore in the housing, with the passage arranged in the wall of the internal cylinder.

22. Valve as claimed in claim 11, wherein the valve is configured to provide for variable adjustment of a damper characteristic curve of a vibration damper.
